(19) United States
(12) Patent Application Publication
(10) Pub. No.: US 2003/0121298 A1
(43) Pub. Date: Jul. 3, 2003

(54) All terrain vehicle lock system

(76) Inventors: Dennis Hancock, Mountain Green, UT (US); Jefferey D. Hancock, Uintah, UT (US)

Correspondence Address: DENNIS HANCOCK, 5752 SILVERSTONE CIRCLE, MOUNTAIN GREEN, UT, 84050, US

(21) Appl. No.: 10/035,289

(22) Filed: Jan. 3, 2002

(51) Int. Cl. G05G 5/00

(52) U.S. Cl. 70/203

(57) ABSTRACT

A method and apparatus for locking an all-terrain vehicle against theft which involves turning the handlebars of an all-terrain vehicle to fully turn the steering wheels of the vehicle in a given direction; positioning an open end of a hardened steel sleeve over the end of the handlebar rotated in the forward direction of the vehicle; tautly stretching a hardened steel chain from the sleeve to wrap around a portion of a rack on the front of the vehicle; and locking the portion of the chain wrapped around the portion of the rack to the chain length extending between the end of the handlebar and the rack to hold the handlebar in its rotated position.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention relates to all-terrain vehicles and particularly to methods and apparatus used to prevent theft of such vehicles.

2. Description of the Related Art

All terrain vehicles (ATV's) are often stolen, particularly when left in the field while an owner goes on foot during hunting trips, to better locate or to retrieve game, or when left alongside a road or in a parking area when the owner goes on foot to a stream, lake or other fishing water. for example.

One particularly popular locking device that is currently used to reduce theft comprises a rigid bar that is clamped to a handlebar of the ATV and to a frame member of the vehicle. Unless this locking device is removed it is not possible to steer the vehicle since the handlebars are secured in a fixed position. However, because of the length and rigidity of the device it is difficult to store it on the vehicle and storage space that can otherwise be used for other necessary or desired objects must be used.

The present invention provides a locking system for all terrain vehicles that requires minimal storage space while still being easy to use to secure the vehicle against theft by all but very determined thieves and that has other potential uses. This locking system, in addition to serving a locking function by preventing travel of the vehicle in any fashion other than in a circle, can also serve as a tow-unit between vehicles and can be used to lock an all-terrain vehicle to another fixed object such as a tree.

### OBJECTS OF THE INVENTION

A principal object of the present invention is to provide a mrethod of locking and an easily attached locking device to secure an all terrain vehicle in a locked condition that will limit travel of the vehicle, with the locking system in place, to travel in a circle Another object is to provide a locking assembly that will fit over the end of a handlebar of the vehicle and that will tautly connect the handlebar to a rack on the front of the vehicle.

Still another object is to provide a locking assembly that can be readily used to lock the frame of an all-terrain vehicle to a fixed object, such as the trunk of a tree.

Yet another object is to provide a locking system for an all-terrain vehicle that is flexible so that it can be compacted to require a minimum of storage space when carried on the vehicle.

### FEATURES OF THE INVENTION

Principal features of the locking system of the invention include a sleeve that will telescope over the end of the handlebar of an all-terrain vehicle and a closed end of the sleeve that will limit telescoping of the sleeve on the end of the handlebar to prevent damage to vehicle controls mounted on the handlebar. A flexible chain has one end fixed to the sleeve adjacent to the open end of the sleeve and an overall length that will allow a free end of the chain to be wrapped around bars of a front rack of the vehicle when the handlebar is fully turned to achieve maximum turning of the vehicle wheels in a desired direction. A padlock is used to secure the free end of the chain to the intermediate length of the chain after the end is wrapped around a bar of the rack.

Other objects and features of the invention will become apparent to those skilled in the art to which the invention pertains from the following detailed description and drawings, disclosing what is presently contemplated as being the best mode of the invention.

### BRIEF DESCRIPTION OF THE FIGURES OF THE DRAWINGS

In the Drawings:

FIG. 1 is a perspective view of an ATV having the lock assembly of the invention mounted on an end of a handlebar of the vehicle and secured to the bars of a front rack of the vehicle according to the locking method of the invention;

FIG. 2, an enlarged perspective view of the lock assembly of the invention; and

FIG. 3, a vertical section through a portion of the lock assembly, taken on the line 3-3 of FIG. 2.

### DETAILED DESCRIPTION

Referring Now to the Drawings:

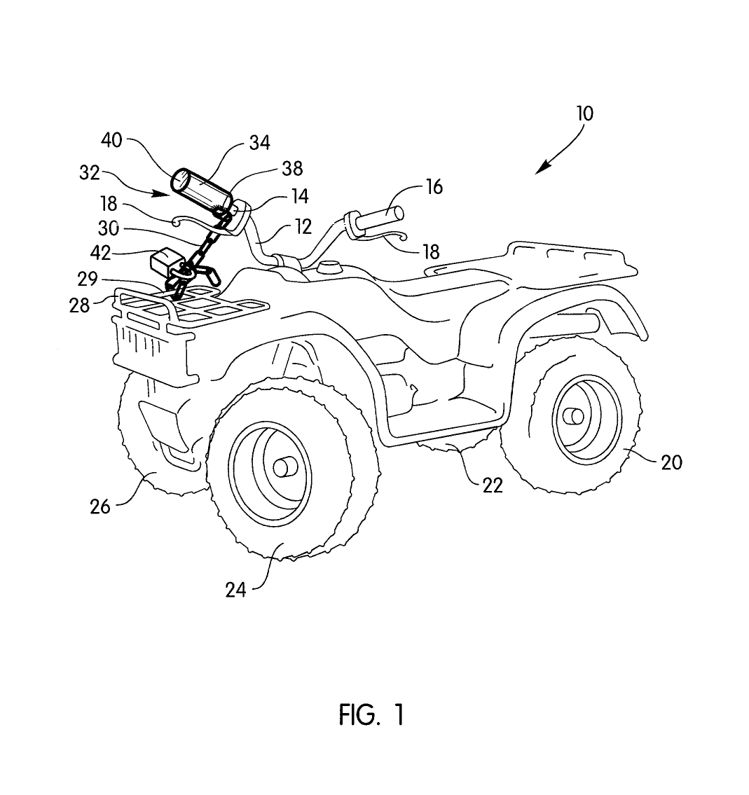

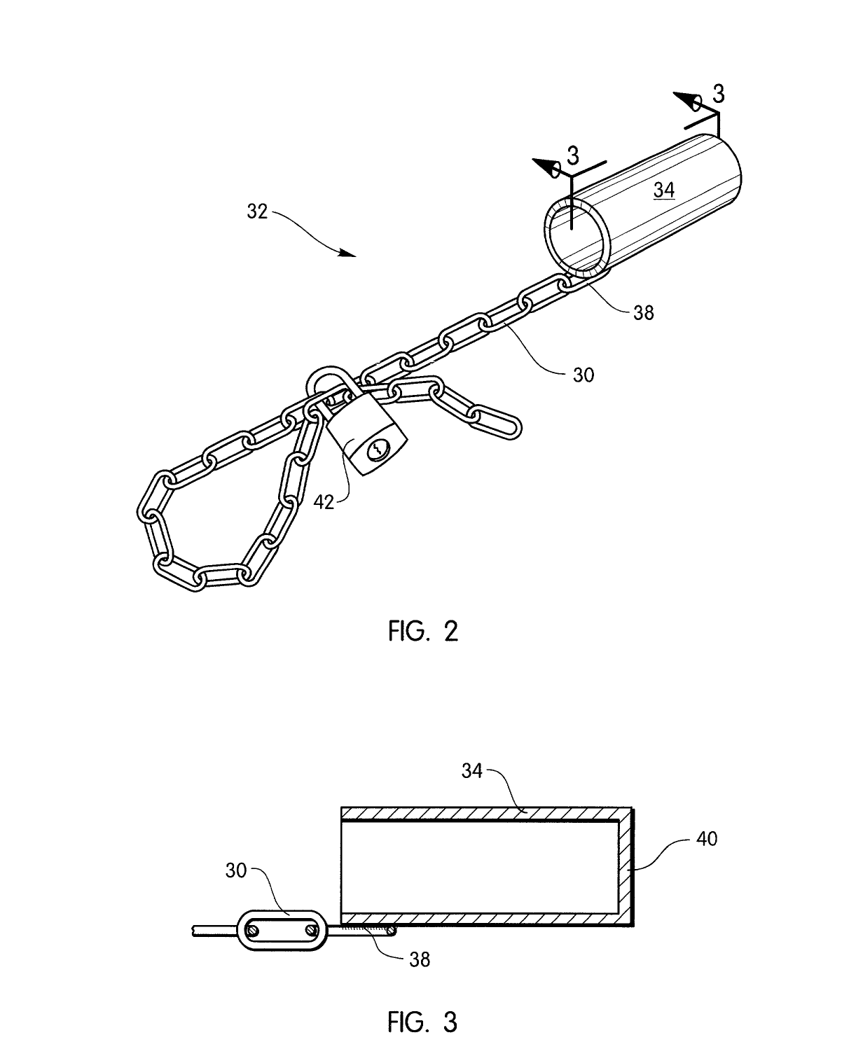

As shown in FIG. 1 an all-terrain vehicle, shown generally at 10 has a handlebar 12 adjacent a front end of the vehicle. The handlebar has handgrips 16 on opposite ends thereof and vehicle control structure, such as the brake lever 14, is mounted on the handlebar 12 adjacent to one handgrip. Another vehicle control structure, i.e. brake lever 18 is provided on the handlebar 12 adjacent to the other handgrip 16. It will be apparent that other vehicle control structures, such as clutch controls, starter buttons, light controls and brake fluid reservoirs can be mounted on the handlebar, in addition to or in place of the brake levers shown.

The all-terrain vehicle 10 further includes the usual rear wheels 20 and 22 and front wheels 24 and 26. A rack 28, having spaced apart bars 29, is mounted to the frame of the vehicle, forward of the handlebar 12. Such front racks are conventional on all-terrain vehicles currently being marketed.

A lock system, shown generally at 32 is secured to the all-terrain vehicle 10. The lock system 32 includes a length of chain 30 and a steel sleeve 34 that has one open end fixed to one end of the length of chain, at 38. The other end of the sleeve 34 is closed at 40. A padlock 42 locks a chain link adjacent the end of the chain length remote from the sleeve 34 to a chain link intermediate the length of the chain. It has been found that a chain length of one-hundred twenty centimeters, or longer, will be long enough to lock most currently available all-terrain vehicles,

In use, the handlebar 12 of an all-terrain vehicle is turned to fully turn the front wheel, of a three-wheeled vehicle or the front wheels of a four-wheeled vehicle, in a selected direction. The open end of sleeve 34 is telescoped onto the handgrip 16 of the end or the handlebar rotated towards the front of the vehicle 10 until the end 40 of the sleeve engages the end of the handgrip. Since the sleeve is unable to continue to travel further onto the handlebar the sleeve cannot damage vehicle controls, such as brake levers, starter button, light controls and brake fluid reservoir that may be mounted on the handlebar. Chain 30 is tautly stretched from the sleeve 34 on the end of handlebar 12 and the free end of the chain is passed around one or more bars 29 of front rack 28 and is turned back on the length of the chain such that the hasp of padlock 42 will pass through a chain link adjacent to the free end of the chain and through a chain link intermediate the length of the chain. If the vehicle is operated without release of the chain it can only travel in the direction dictated by the fully turned wheels. Preferably, the chain, sleeve and padlock are all made of hardened steel that will make it even more difficult for a thief to break the lock system.

It will be obvious that the lock system 10 can also be used for other purposes. For example, the chain 30 can be wrapped around a frame portion of the vehicle and around a tree, or other fixed object before padlocking the ends of the chain length together. In the same manner, the chain can be interconnected between vehicles when the vehicle is used to tow another vehicle.

Although a preferred form of our invention has been herein disclosed, it is to be understood that the present disclosure is by way of example and that variations are possible without departing from the subject matter coming within the scope of the following claims, which subject matter we regard as our invention.

We claim:

1, An all-terrain vehicle lock assembly comprising
a length of chain;
a steel sleeve having one open end and one closed end, one end of said length of chain being fixed adjacent to said open end of said sleeve and said sleeve having a length that is just greater than the width of a human hand; and
a padlock with a hasp that will pass through links of said chain.

2. An all-terrain vehicle lock assembly as in claim 1, wherein the chain has a length of at least about one hundred twenty centimeters.

3. An all-terrain vehicle lock assembly as in claim 2, wherein the chain, the sleeve and the padlock are all made of hardened steel

4. A method of locking an all-terrain vehicle against theft of the vehicle comprising
(a) turning the handlebar of said vehicles to fully turn each front wheel of said vehicle in a desired direction;
(b) locking a handgrip on one end of the handlebar to a front rack of the vehicle.

5. A method of locking an all-terrain vehicle against theft of the vehicle as in claim 4 further including
(c) enclosing the one end of the handlebar; and
(c) tautly stretching a chain between said one end of the handlebar and the front rack of the vehicle,
